(19) United States
(12) Patent Application Publication
(10) Pub. No.: US 2022/0042195 A1
(43) Pub. Date: Feb. 10, 2022

(54) METHOD FOR PREPARING COPPER-BASED GRAPHENE/ALUMINUM COMPOSITE WIRE WITH HIGH ELECTRICAL CONDUCTIVITY

(71) Applicant: CHANGZHOU UNIVERSITY, Changzhou (CN)

(72) Inventors: Wei WEI, Changzhou (CN); Feilong JIA, Changzhou (CN); Fuqiang CHU, Changzhou (CN); Kunxia WEI, Changzhou (CN); Qingbo DU, Changzhou (CN); Jing HU, Changzhou (CN)

(73) Assignee: CHANGZHOU UNIVERSITY, Changzhou (CN)

(21) Appl. No.: 17/433,247

(22) PCT Filed: Aug. 3, 2020
(86) PCT No.: PCT/CN2020/106520

§ 371 Date: Aug. 24, 2021

(30) Foreign Application Priority Data
Aug. 9, 2019 (CN) 201910732824.0

(51) Int. Cl. C25D 1/04; C25D 15/00; H01B 13/00

(52) U.S. Cl. CPC C25D 1/04; C25D 15/00; H01B 13/0026; H01B 13/0016; H01B 13/0006

(57) ABSTRACT

A method for preparing a copper-based graphene/aluminum composite wire with high electrical conductivity is disclosed. An electrodeposition solution for the wire includes the following components, in mass percentage: 20 wt % of CuSO₄, 0.005 wt % to 0.020 wt % of benzalacetone, 2 wt % to 5 wt % of NaCl, 0.08 wt % to 0.5 wt % of graphene, 0.003 wt % to 0.016 wt % of N,N-dimethylformamide (DMF), and the balance of deionized water. The preparation process of the wire is composed of: electrodeposition, drawing, and annealing. The obtained wire has excellent electrical conductivity and tensile strength, which can effectively improve the electric power transmission efficiency and reduce the electrical power loss. By the above electrodeposition solution and simple preparation method, a utility model wire with high transmission efficiency can be prepared, where the comprehensive performance and microstructure of the composite can be ensured by controlling process parameters.

### CROSS REFERENCE TO THE RELATED APPLICATIONS

This application is the national phase entry of International Application No. PCT/CN2020/106520, filed on Aug. 3, 2020, which is based upon and claims priority to Chinese Patent Application No. 201910732824.0, filed on Aug. 9, 2019, the entire contents of which are incorporated herein by reference.

### TECHNICAL FIELD

The present invention belongs to the technical fields of wires and cables, and specifically relates to a method for preparing a copper-based graphene/aluminum composite wire with high electrical conductivity.

### BACKGROUND

Metal has a long widely application in the wire and cable for electric power transportation and signal transmission. In recent years, the emergence of some new materials is expected to break the existing pattern. Due to excellent comprehensive performance, graphene has become a new material that urgently needs to be developed.

Graphene has a hexagonal honeycomb-shaped two-dimensional (2D) planar structure composed of a single layer of atoms (sp²-hybridized carbon atoms), which is a structural unit constituting graphite. Graphene has many excellent physical properties, such as ultra-high electron mobility as high as 2.5×10⁵ cm²V⁻¹s⁻¹. Monolayer graphene has Young's modulus of 130 GPa and thermal conductivity of 5,000 W/m·K. These excellent properties allow graphene to have a promising future. However, as a two-dimensional (2D) material, graphene can hardly be shaped alone, and preparing a composite from graphene and a metal through a specific method can effectively improve the performance of graphene.

Plain wires are only suitable for power transmission at ordinary frequencies, but for the transmission and transduction of high-frequency electric power and signals, traditional copper/aluminum, copper/steel, aluminum alloy wires and cables can no longer meet the requirements. At present, such a problem is solved mainly by plating gold/silver or adding a semiconductor material layer, but the use of gold/silver itself brings high cost and heavy pollution, resulting in great limitations.

At present, metal-based graphene composite materials can be prepared by many methods, mainly including powder metallurgy, hydrothermal synthesis, vapor deposition, electrodeposition, and so on. The powder metallurgy method shows poor controllability and many limitations. The hydrothermal synthesis shows strong controllability and high material purity, but is more technically difficult. Although the vapor deposition shows strong controllability and leads to a dense and uniform coating, the coating is generally so thin that is not conducive to practical application. In a method of electrodeposition, a rapid growth material is fabricated by electrochemical oxidation and reduction using a prepared electrolyte solution with a specific composition as a medium, which has the advantages of simple process, uniform coating with controllable size, etc., but there is also some disadvantages, such as selecting the composition of the electrodeposition solution, substrate material and process parameters, which will directly affect the structure and performance of a prepared composite. For example, prepared by an unimproved electrodeposition solution, the copper-based graphene composite has poor density, relatively-coarse crystal grains, and performance that is not significantly improved compared to pure copper.

### SUMMARY

In order to solve the above technical problem, the present disclosure provides a method for preparing a composite wire with high conductivity and prominent high-frequency transmission performance. The present disclosure is not only intended to provide an electrodeposition solution for a copper-based graphene composite that is reasonable in component ratio, environmentally friendly, low in cost, and controllable in thickness of deposited layer, but also give the required process parameters and techniques, so as to fabricate a composite wire with excellent performance. The present disclosure adopts the following technical solutions:

The present disclosure provides a method for preparing a copper-based graphene/aluminum (alloy) composite wire by electrodeposition, including the following steps:

(1) An electrodeposition solution for a copper-based graphene composite is prepared, where the electrodeposition solution may include the following components, in mass percentage: 20 wt % of CuSO₄, 0.005 wt % to 0.020 wt % of benzalacetone, 2 wt % to 5 wt % of NaCl, 0.08 wt % to 0.5 wt % of graphene, 0.003 wt % to 0.016 wt % of N,N-dimethylformamide (DMF), and the balance of deionized water.

The benzalacetone is adopted as a grain refiner, which affects the cathode overpotential and nucleation rate during the electrodeposition process. An appropriate amount of benzalacetone allows the material to have a fine-grained structure with high-density twins. The DMF is added to improve the dispersibility of graphene and reduce agglomeration without introducing other functional groups, thus reducing micro and macro defects in the composite material and increasing the density of the material.

(2) Pulse electrodeposition is conducted on an aluminum (alloy) substrate with the prepared electrodeposition solution under the following process parameters: 2:1 to 5:1 of pulse width ratio (positive/negative), 2 v to 3 v/0.5 v to 1 v of pulse voltage, 400 Hz to 800 Hz of pulse current frequency, 30° C. of temperature, and 1 h to 4 h of electrodeposition time. The change in pulse width, pulse voltage, frequency, temperature, and other parameters will affect a deposition rate of the material and a quality of a deposited layer.

(3) The deposited copper-based graphene/aluminum (alloy) composite wire is treated by a drawing process as follows: the copper-based graphene/aluminum composite wire is drawn at a high temperature of 130° C. to 330° C. and a drawing speed of 10 mm/min to 30 mm/min to obtain a wire with a diameter of 0.8 mm to 1.4 mm.

(4) The wire obtained after the drawing process is subjected to annealing treatment in an annealing furnace under the following process parameters: nitrogen atmosphere; annealing temperature: 30° C. to 130° C.; and treatment time: 2 h to 4 h. The annealing treatment is conducted to improve the performance of the composite and the interface bonding strength of the composite.

The copper sulfate-graphene electrodeposition solution used in the present disclosure is non-toxic, reasonable in component ratio, and recyclable, resulting in reduced cost and environmental friendliness. A copper-based graphene coating prepared from the electrodeposition solution has a bright surface and a dense structure. The copper-based graphene/aluminum composite wire prepared in the present disclosure is used in the technical fields of wires and cables. The deposited layer may have a volume percentage of 10% to 30%.

The additives can increase the nucleation rate and hinder the growth of crystals. With an appropriate amount of additives, nano-sized crystal grains can be obtained. There are a large number of nano-sized crystal grains and nano-twins in the structure of the material, which can effectively improve the electrical conductivity and mechanical properties of the material.

Function mechanism: nano-crystals and twins can effectively reduce the scattering of energy by grain boundaries and reduce energy loss during transmission. According to the Hall-Petch equation, the size reduction of crystal grains will be accompanied by an increase in strength; and the presence of graphene in the material can effectively improve the electron mobility of the material and promotes the transmission and transduction efficiency of high-frequency signals.

Beneficial effects of the present disclosure:

(1) Pulse electrodeposition is adopted in the electrodeposition, which is low-cost and relatively simple, and leads to a uniform and dense coating that has a bright surface without rough and convex particles. There are a large number of nano-crystals in the microstructure.

(2) The deposited layer of the present disclosure has excellent electrical conductivity and mechanical properties. Compared with the aluminum alloy wire substrate, the wire of the present disclosure has a strength increased by more than 30% and an electrical conductivity close to that of standard annealed pure copper.

(3) The material of the present disclosure can have an electrical conductivity as high as more than 90% IACS and a tensile strength as high as 490±10 MPa. The deposited layer greatly improves the practicability and applicability of the material.

### DETAILED DESCRIPTION OF THE EMBODIMENTS

The present disclosure will be described in further detail below in conjunction with examples, but these examples are used only to illustrate the present disclosure rather than limit the scope of the present disclosure. In the examples, pulse voltage of 2.5 v/0.8 v and electrodeposition frequency of 500 Hz are adopted for illustration.

### EXAMPLE 1

An electrodeposition solution for copper-based graphene was prepared, and the electrodeposition solution had the following components, in mass percentage: 20 wt % of CuSO₄, 0.005 wt % of benzalacetone, 2 wt % of NaCl, 0.08 wt % of few-layer graphene, and 0.003 wt % of DMF. Electrodeposition was conducted at 30° C. under the following process parameters: 2:1 of pulse width ratio (positive/negative), 2.5 v/0.8 v of pulse voltage, 500 Hz of pulse current frequency, and 1 h of electrodeposition time.

After the electrodeposition was completed, a drawing process was conducted that the copper-based graphene/aluminum composite wire was drawn at a high temperature of 130° C. and a drawing speed of 10 mm/min to obtain a wire with a diameter of 1.4 mm.

The wire was then subjected to annealing treatment in an annealing furnace under the following process parameters: nitrogen atmosphere, 30° C. of annealing temperature, and 2 h of treatment time.

Under the above conditions, a deposited layer had a volume percentage of 10% and exhibited a prominent binding property with the aluminum core wire; and a prepared material had an electrical conductivity as high as 75.4% IACS and a tensile strength as high as 410±10 MPa.

### EXAMPLE 2

An electrodeposition solution for copper-based graphene was prepared, and the electrodeposition solution had the following components, in mass percentage: 20 wt % of CuSO₄, 0.010 wt % of benzalacetone, 3 wt % of NaCl, 0.2 wt % of few-layer graphene, and 0.008 wt % of DMF. Electrodeposition was conducted at 30° C. under the following process parameters: 3:1 of pulse width ratio (positive/negative), 2.5 v/0.8 v of pulse voltage, 500 Hz of pulse current frequency, and 2 h of electrodeposition time.

After the electrodeposition was completed, a drawing process was conducted, that is, the copper-based graphene/aluminum composite wire was drawn at a high temperature of 230° C. and a drawing speed of 20 mm/min to obtain a wire with a diameter of 1.0 mm.

The wire was then subjected to annealing treatment in an annealing furnace under the following process parameters: nitrogen atmosphere, 80° C. of annealing temperature, and 3 h of treatment time.

Under the above conditions, a deposited layer had a volume percentage of 15% and exhibited a prominent binding property with the aluminum core wire; and a prepared material had an electrical conductivity as high as 83.3% IACS and a tensile strength as high as 445±10 MPa.

### EXAMPLE 3

An electrodeposition solution for copper-based graphene was prepared, and the electrodeposition solution had the following components, in mass percentage: 20 wt % of CuSO₄, 0.015 wt % of benzalacetone, 3 wt % of NaCl, 0.4 wt % of few-layer graphene, and 0.012 wt % of DMF. Electrodeposition was conducted at 30° C. under the following process parameters: 5:1 of pulse width ratio (positive/negative), 2.5 v/0.8 v of pulse voltage, 500 Hz of pulse current frequency, and 4 h of electrodeposition time.

After the electrodeposition was completed, a drawing process was conducted, that is, the copper-based graphene/aluminum composite wire was drawn at a high temperature of 330° C. and a drawing speed of 30 mm/min to obtain a wire with a diameter of 0.8 mm.

The wire was then subjected to annealing treatment in an annealing furnace under the following process parameters: nitrogen atmosphere, 130° C. of annealing temperature, and 3.5 h of treatment time.

Under the above conditions, a deposited layer had a volume percentage of 30% and exhibited a prominent binding property with the aluminum core wire; and a prepared material had an electrical conductivity as high as 90.2% IACS and a tensile strength as high as 490±10 MPa.

### EXAMPLE 4

An electrodeposition solution for copper-based graphene was prepared, and the electrodeposition solution had the following components, in mass percentage: 20 wt % of CuSO₄, 0.020 wt % of benzalacetone, 4 wt % of NaCl, 0.5 wt % of few-layer graphene, and 0.016 wt % of DMF. Electrodeposition was conducted at 30° C. under the following process parameters: 5:1 of pulse width ratio (positive/negative), 2.5 v/0.8 v of pulse voltage, 500 Hz of pulse current frequency, and 4 h of electrodeposition time.

After the electrodeposition was completed, a drawing process was conducted, that is, the copper-based graphene/aluminum composite wire was drawn at a high temperature of 330° C. and a drawing speed of 30 mm/min to obtain a wire with a diameter of 0.9 mm.

The wire was then subjected to annealing treatment in an annealing furnace under the following process parameters: nitrogen atmosphere, 130° C. of annealing temperature, and 4 h of treatment time.

Under the above conditions, a deposited layer had a volume percentage of 25% and exhibited a prominent binding property with the aluminum core wire; and a prepared material had an electrical conductivity as high as 86.7% IACS and a tensile strength as high as 465±10 MPa.

### Comparative Example 1

An electrodeposition solution for copper-based graphene was prepared, and the electrodeposition solution had the following components, in mass percentage: 20 wt % of CuSO₄, 0.015 wt % of benzalacetone, 3 wt % of NaCl, 0.4 wt % of few-layer graphene, and 0.012 wt % of DMF. Electrodeposition was conducted at 30° C. under the following process parameters: 5:1 of pulse width ratio (positive/negative), 2.5 v/0.8 v of pulse voltage, 500 Hz of pulse current frequency, and 4 h of electrodeposition time. After the electrodeposition was completed, a deposited layer was loose and incompact and exhibited a poor binding force with the substrate.

### Comparative Example 2

An electrodeposition solution for copper-based graphene was prepared, and the electrodeposition solution had the following components, in mass percentage: 20 wt % of CuSO₄, 0.015 wt % of benzalacetone, 3 wt % of NaCl, 0.4 wt % of few-layer graphene, and 0.012 wt % of DMF. Electrodeposition was conducted at 30° C. under the following process parameters: 5:1 of pulse width ratio (positive/negative), 2.5 v/0.8 v of pulse voltage, 500 Hz of pulse current frequency, and 4 h of electrodeposition time.

After the electrodeposition was completed, a drawing process was conducted, that is, the copper-based graphene/aluminum composite wire was drawn at a high temperature of 330° C. and a drawing speed of 30 mm/min to obtain a wire with a diameter of 0.8 mm.

Under the above conditions, a deposited layer had a volume percentage of 30% and exhibited a prominent binding property with the aluminum core wire; and a prepared material had an electrical conductivity as high as 86.2% IACS and a tensile strength as high as 450±10 MPa.

### Comparative Example 3

An electrodeposition solution for copper-based graphene was prepared, and the electrodeposition solution had the following components, in mass percentage: 20 wt % of CuSO₄, 3 wt % of NaCl, 0.4 wt % of few-layer graphene, and 0.012 wt % of DMF. Electrodeposition was conducted at 30° C. under the following process parameters: 5:1 of pulse width ratio (positive/negative), 2.5 v/0.8 v of pulse voltage, 500 Hz of pulse current frequency, and 4 h of electrodeposition time.

After the electrodeposition was completed, a drawing process was conducted, that is, the copper-based graphene/aluminum composite wire was drawn at a high temperature of 330° C. and a drawing speed of 30 mm/min to obtain a wire with a diameter of 0.8 mm.

The wire was then subjected to annealing treatment in an annealing furnace under the following process parameters: nitrogen atmosphere, 130° C. of annealing temperature, and 3.5 h of treatment time.

Under the above conditions, a deposited layer had a volume percentage of 28% and exhibited an average binding property with the aluminum core wire and poor surface quality; and a prepared material had an electrical conductivity as high as 84.6% IACS and a tensile strength as high as 440±10 MPa.

The above examples are preferred implementations of the present disclosure, but the present disclosure is not limited to the above implementations. Any obvious improvement, substitution, or modification made by those skilled in the art without departing from the essence of the present disclosure should fall within the protection scope of the present disclosure.

What is claimed is:

1. A method for preparing a copper-based graphene/aluminum composite wire with a high electrical conductivity, comprising the following steps:
(1) preparing an electrodeposition solution for a copper-based graphene composite;
(2) conducting an electrodeposition on an aluminum wire or an aluminum alloy wire with the electrodeposition solution in step (1) to obtain a first copper-based graphene/aluminum composite wire product, wherein the electrodeposition used refers to a pulse electrodeposition;
(3) drawing the first copper-based graphene/aluminum composite wire product obtained in step (2) at a high temperature to obtain a second copper-based graphene/aluminum composite wire product with a diameter of 0.8 mm to 1.4 mm; and
(4) subjecting the second copper-based graphene/aluminum composite wire product obtained in step (3) to an annealing treatment in a nitrogen atmosphere to obtain the copper-based graphene/aluminum composite wire with the high electrical conductivity; wherein
the electrodeposition solution for the copper-based graphene composite in step (1) comprises the following components in mass percentage: 20 wt % of CuSO₄, 0.005 wt % to 0.020 wt % of benzalacetone, 2 wt % to 5 wt % of NaCl, 0.08 wt % to 0.5 wt % of graphene, 0.003 wt % to 0.016 wt % of N,N-dimethylformamide (DMF), and a balance of deionized water.

2. (canceled)

3. The method for preparing the copper-based graphene/aluminum composite wire with the high electrical conductivity according to claim 1, wherein the electrodeposition in step (2) is conducted under the following sinusoidal pulse parameters: 2:1 to 5:1 of pulse width ratio (positive/negative), 2 v to 3 v/0.5 v to 1 v of pulse voltage, and 400 Hz to 800 Hz of pulse current frequency.

4. The method for preparing the copper-based graphene/aluminum composite wire with the high electrical conductivity according to claim 1, wherein copper-based graphene has a volume percentage of 10% to 30% in the first copper-based graphene/aluminum composite wire product prepared in step (2).

5. The method for preparing the copper-based graphene/aluminum composite wire with the high electrical conductivity according to claim 1, wherein the drawing in step (3) is conducted at a temperature of 130° C. to 330° C. and a drawing speed of 10 mm/min to 30 mm/min.

6. The method for preparing the copper-based graphene/aluminum composite wire with the high electrical conductivity according to claim 1, wherein the annealing treatment in step (4) is conducted at 30° C. to 130° C., with a temperature-holding time of 2 h to 4 h.

7. A copper-based graphene/aluminum composite wire with a high electrical conductivity prepared by the method according to claim 1, wherein the copper-based graphene/aluminum composite wire has an electrical conductivity of no less than 75% IACS and a tensile strength of 500 MPa.

8. An application of the copper-based graphene/aluminum composite wire with the high electrical conductivity prepared by the method according to claim 1 in technical fields of wires and cables.
